(19) United States
(12) Patent Application Publication
(10) Pub. No.: US 2002/0005172 A1
(43) Pub. Date: Jan. 17, 2002

(54) CONSTRUCTION INCLUDING AN IMPLEMENT FOR MILKING ANIMALS AS WELL AS A METHOD THEREOFF

(76) Inventor: CORNELIS VAN DER LELY, BRUSCHENRAIN (CH)

Correspondence Address: MASON MASON & ALBRIGHT, POST OFFICE BOX 2246, ARLINGTON, VA, 222020246

(21) Appl. No.: 09/270,460

(22) Filed: Mar. 15, 1999

Related U.S. Application Data
(63) Continuation of application No. PCT/NL98/00389, filed on Jul. 8, 1998.

(30) Foreign Application Priority Data
Jul. 15, 1997 (NL) 1006586
Jul. 8, 1998 (US) PCTNL9800389

(51) Int. Cl. A01J 3/00; A01J 5/00

(52) U.S. Cl. 119/14.02

(57) ABSTRACT

An adjusting member which comprises a computer which is included in an apparatus for automatically milking animals and which adjusts the period the time that the animal is milked during a milking run to obtain optimal milk production from the animal over an extended period of time. A time duration plot of the milking run is initially determined based on milk quantity produced by the animal per unit time whereby an optimal duration of milking time during a milking run is calculated by the computer in consideration of the total milk produced by the animal over an extended period of time and the period of time according to the time duration plot that the milk flow rate is optimal. By limiting the duration of a milking run to approximately three minutes it has been determined that the total amount of milk produced by the animal over an extended period such as twenty-four hours is increased. The adjusting member also controls the rate that milk is removed from the teat cups connected to the teats of the animal during milking runs by controlling the milk pump or vacuum (or both) that governs the rate the milk is removed.

The invention relates to a construction including an implement and to a method of milking animals, such as cows.

Such implements are known.

The invention aims at yielding more milk by means of the above-mentioned implement and/or method. In accordance with the invention, this is achieved in that the implement is provided with adjusting means with the aid of which the milking duration, i.e. the period of time in which the animal is milked, is adjustable. In this manner it is possible to choose a favourable milking duration, in such a manner that this results in a higher milk production. According to an inventive feature, the milking duration is variably adjustable. According to again another inventive feature, the milking duration can be adjusted per animal. This makes it possible to classify the animals on the basis of their milk production. According to another inventive feature, the adjusting means comprise a computer.

According to again another aspect of the invention, the implement is provided with a sensor by means of which the milk quantity per unit of time of the animal can be established during milking. According to another aspect of the invention, during milking of the animal, the milk quantity per unit of time established by the sensor is inputted per animal into the memory of the computer. According to again another inventive feature, the computer comprises calculating means with the aid of which changes in the milk quantity per unit of time are calculated during milking. On the basis of the milk quantity per unit of time and the milk production derived therefrom, there can be determined a criterion for the milking duration. According to again another inventive feature, there are inputted into the memory of the computer one or more threshold values for dividing the milk quantity per unit of time into flow stretches. In this manner it is possible to divide the milk quantity yielded per unit of time during a milking run into a number of stages in which the milk quantity yielded per unit of time is approximately equal.

In accordance with again another inventive feature, the adjusting means comprise a vacuum and/or milk pump which are/is connected to a teat cup. For the purpose of influencing the milking rate, according to an inventive feature, the capacity of the vacuum and/or milk pump is variably adjustable. According to an aspect of the invention, the adjusting means comprise a control mechanism by means of which the vacuum and/or milk pump is adjusted on the basis of the changes in the milk quantity per unit of time during milking. When it appears that an animal easily gives milk during a specific period of time, by means of the control mechanism the capacity of the vacuum and/or milk pump can be increased, so that the milk is yielded at a higher rate. In this manner a large quantity of milk can be yielded during a short period of time.

According to a further inventive feature, the adjusting means comprise time adjusting means with the aid of which the duration of a milking run can be adjusted per animal. This enables only to milk the animal during that time when the milk quantity yielded per unit of time is relatively large. In a preferred embodiment of the invention, the duration of a miking run amounts to approximately 3 minutes. Such a duration has appeared to result in a very high milk production per day.

According to another inventive feature, on the basis of the milk quantity per unit of time determined by the sensor and the milk production derived therefrom, the duration of the milking run is calculated by the computer, in such a manner that there is obtained a high milk production per animal.

In a preferred embodiment of the invention, the implement comprises a milking robot for automatically connecting teat cups to the teats of an animal to be milked.

The invention further relates to a method of automatically milking animals, such as cows, in which method during milking an animal, on the basis of the milk quantity yielded per unit of time and the changes therein, it is determined during what period of time the animal gives the largest milk quantity per unit of time, and, with the aid of these data, the duration of the milking run is established, in such a manner that a higher milk production per animal is obtained. According to an inventive feature, by means of the milk quantity yielded per unit of time and the changes therein, the rate c.q. the capacity of a vacuum and/or milk pump for the teat cup is adjusted.

The invention will be explained in further detail with reference to the accompanying diagrams and drawing.

FIG. 1 shows a diagram in which the milking rate in quantity per unit of time and the milk production in quantity are set out against time;

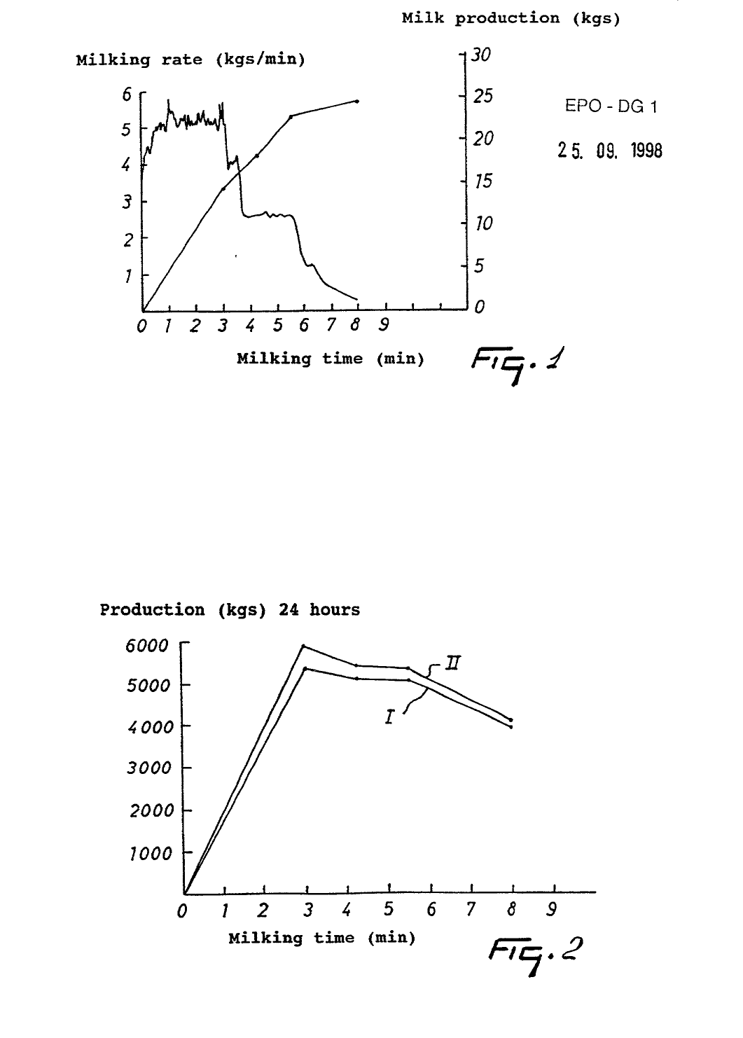

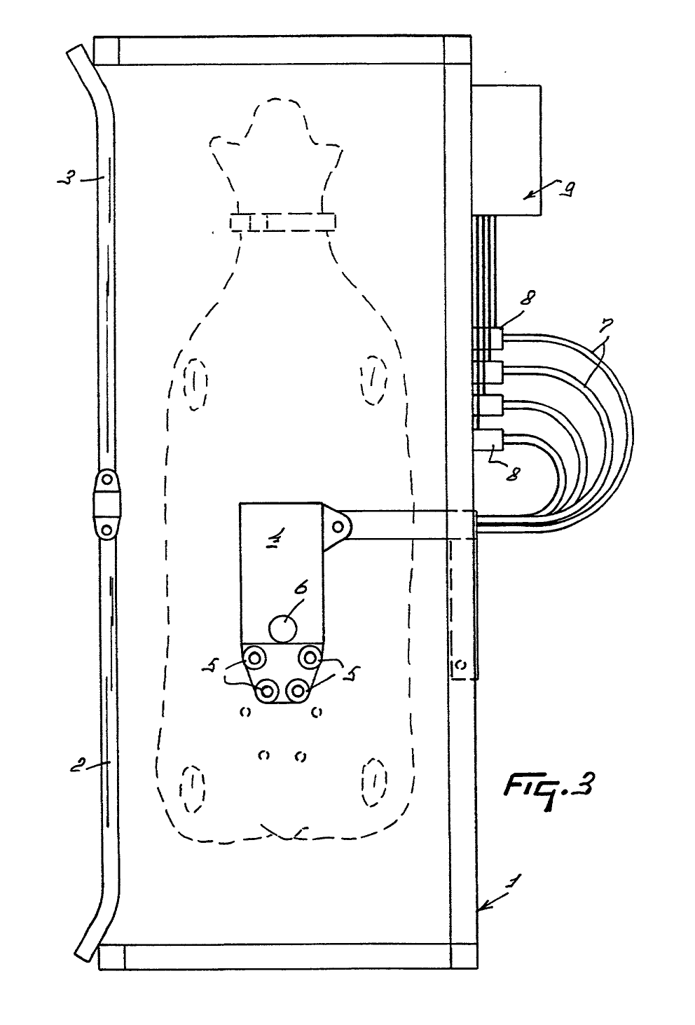

FIG. 2 shows a diagram in which the milk quantity yielded per 24 hours is set out against the milking time;

FIG. 3 shows a plan view of a milk box including a milking robot according to the invention.

FIGS. 1 and 2 will be explained in further detail with reference to the undermentioned tables, in the second one of which it is assumed that the time in which the teat cups are connected to the teats of an animal to be milked is four times as short as in table 1. The teat cups may be connected to the teats of an animal to be milked both by hand and by means of a milking robot.

TABLE 1

| | | | | number | produc- | |
|---|---|---|---|---|---|---|
| | cow in/ | connec- | | of | tion | produc- |
| | cow out | tion of | | milking | per | tion |
| milking | of | the teat | total | runs | milking | per |
| time | milkbox | cups | time | per | run | 24 h. |
| (min.) | (min.) | (min.) | (min.) | 24 h. | (kg) | (kg) |
| 3 | 0.5 | 0.4 | 3.9 | 369 | 14.5 | 5,354 |
| 4.2 | 0.5 | 0.4 | 5.1 | 282 | 18 | 5,082 |
| 5.5 | 0.5 | 0.4 | 6.4 | 225 | 22.5 | 5,062 |
| 8 | 0.5 | 0.4 | 8.9 | 162 | 24.5 | 3,964 |

TABLE 2

| | | | | number | produc- | |
|---|---|---|---|---|---|---|
| | cow in/ | connec- | | of | tion | produc- |
| | cow out | tion to | | milking | per | tion |
| milking | of | the teat | total | runs | milking | per |
| time | milkbox | cups | time | per | run | 24 h. |
| (min.) | (min.) | (min.) | (min.) | 24 h. | (kg) | (kg) |
| 3 | 0.5 | 0.1 | 3.6 | 400 | 14.5 | 5,800 |
| 4.2 | 0.5 | 0.1 | 4.8 | 300 | 18 | 5,400 |
| 5.5 | 0.5 | 0.1 | 6.1 | 236 | 22.5 | 5,311 |
| 8 | 0.5 | 0.1 | 8.6 | 167 | 24.5 | 4,102 |

FIG. 1 shows a diagram based on an average cow which appears to have a milking time of approximately 8 minutes and whose milking rate pattern during these 8 minutes is indicated by the curve in FIG. 1. The milking rate curve is divided into four stretches having a different average milking rate. The transition of one stretch to the other is shown in table 1. For example, the first stretch passes from 0 to 3 minutes; the second stretch from 3 to 4.2 minutes; the third stretch from 4.2 to 5.5 minutes and the fourth stretch from 5.5 to 8 minutes. FIG. 1 furthermore shows the milk production after passing through the first, second, third and fourth stretches. By choosing a favourable stretch and consequently a favourable duration of time in which the animal is milked, there is yielded a larger quantity of milk per 24 hours, as shown in Tables 1 and 2. This is due to the fact that the milking machine is only used during that period of time in which the cow gives her milk at the highest rate. The time during which the animal is milked, e.g. 3 minutes, may be adjusted by hand or, as described in the foregoing, may be calculated and adjusted fully automatically by the computer. Starting from a shorter connection time of the teat cups to the teats of an animal to be milked results in a still higher milk production, as shown in FIG. 2 and Table 2.

FIG. 3 shows a plan view of a milk box 1 provided with an entrance door 2 and an exit door 3. Near a longitudinal side of the milk box 1 there is arranged a milking robot 4 which carries four teat cups 5 near one of its ends. The milking robot 4 is further provided with a sensor 6 for determining the position of the teats of an animal to be milked. The sensor 6 may e.g. be designed as a laser sensor, un ultrasonic sensor or a camera. Each of the teat cups 5 is further provided with a milk hose 7. Each of the milk hoses 7 is connected to a flow meter 8 by means of which during milking the milk quantity yielded per udder quarter can be determined. The flow meters 8 are further connected to a computer 9.

The function is as follows:

By means of a measuring device the milking rate (l/min.) per udder quarter is measured. The information obtained therefrom is converted in the computer so that at any moment the quantity of milk produced (l) is known (cumulatively). When this quantity exceeds a specific value (the optimal quantity), this is indicated in the vicinity of the milking machine by means of a visual signal or an auditive signal, so that the operating person of the milking machine knows that the milking machine has to be disconnected. This signal is preferably activated when the optimal milk quantity has been reached in all quarters. When a milking robot is applied, the robot arm will be given a command to disconnect the teat cup.

1. A construction including an implement for milking animals, such as cows, as well as a method thereof, characterized in that the implement is provided with adjusting means with the aid of which the milking duration, i.e. the period of time in which the animal is milked, is adjustable.

2. A construction as claimed in claim 1, characterized in that the milking duration is variably adjustable.

3. A construction as claimed in claim 1 or 2, characterized in that the milking duration is adjustable per animal.

4. A construction as claimed in claim 1 or 2, characterized in that the milking duration is automatically adjustable.

5. A construction including an implement for milking animals, such as cows, characterized in that the implement comprises means for variably adjusting the milking duration, for the purpose of obtaining a higher milk production.

6. A construction as claimed in any one of the preceding claims, characterized in that the adjusting means comprise a computer.

7. A construction as claimed in any one of the preceding claims, characterized in that the implement is provided with a sensor by means of which the milk quantity per unit of time of the animal can be established during milking.

8. A construction as claimed in claim 7, characterized in that during milking an animal the milk quantity per unit of time established by the sensor is inputted per animal into the memory of the computer.

9. A construction as claimed in claim 7 or 8, characterized in that the computer comprises calculating means with the aid of which changes in the milk quantity per unit of time are calculated during milking.

10. A construction as claimed in any one of claims 7 to 9, characterized in that into the memory of the computer there is inputted at least one threshold value for dividing the milk quantity per unit of time into flow stretches.

11. A construction as claimed in any one of the preceding claims, characterized in that the adjusting means comprise a vacuum and/or milk pump which are/is connected to one or more teat cups.

12. A construction as claimed in claim 11, characterized in that the capacity of the vacuum and/or milk pump is variably adjustable.

13. A construction as claimed in claim 12, characterized in that the adjusting means comprise a control mechanism by means of which the vacuum and/or milk pump is adjusted on the basis of the changes in the milk quantity per unit of time during milking.

14. A construction as claimed in any one of the preceding claims, characterized in that the adjusting means comprise time adjusting means with the aid of which the duration of a milking run can be adjusted per animal.

15. A construction as claimed in any one of the preceding claims, characterized in that there has been recorded in the time adjusting means that the duration of the milking run amounts to approximately 3 minutes.

16. A construction as claimed in any one of the preceding claims, characterized in that, on the basis of the milk quantity per unit of time determined by the sensor and the milk quantity derived therefrom, the duration of the milking run is calculated by the computer, in such a manner that there is obtained a high milk production per animal.

17. A construction as claimed in any one of the preceding claims, characterized in that the implement comprises a milking robot for automatically connecting teat cups to the teats of an animal to be milked.

18. A construction as claimed in any one of the preceding claims, characterized in that the implement comprises a sensor by means of which the milking rate is determined.

19. A construction as claimed in claim 18, characterized in that the implement comprises a calculating unit which, on the basis of the milking rate, determines the quantity of milk produced.

20. A construction as claimed in any one of the preceding claims, characterized in that the computer comprises a memory in which there is recorded per animal which animal has been milked and what is the optimal milk production per animal and/or per udder quarter.

21. A construction as claimed in any one of the preceding claims, characterized in that in the computer the actual milk yield is compared with the optimal milk yield and that, when the actual milk yield has achieved or exceeded the optimal milk yield, milking is ended.

22. A construction as claimed in claim 21, characterized in that, when milking is ended, the implement supplies a signal.

23. A construction as claimed in claim 22, characterized in that the supplied signal is a control signal for putting the milking robot out of operation.

24. A construction as claimed in any one of the preceding claims, characterized in that the construction comprises at least one air pump and one liquid pump.

25. A construction as claimed in claim 24, characterized in that the milk production can be controlled by means of a further pump.

26. A construction as claimed in any one of the preceding claims, characterized in that the milking rate can be controlled by means of another pump.

27. A method which can be applied in the construction as claimed in any one of claims 1 to 26.

28. A method of milking animals, such as cows, in which, during milking an animal, on the basis of the milk quantity yielded per unit of time and the changes therein, it is determined during what period of time the animal gives the largest milk quantity per unit of time, and, with the aid of these data the duration of the milking run is established, in such a manner that a higher milk production per animal is obtained.

29. A method as claimed in claim 27 and/or 28, characterized in that, with the aid of the milk quantity yielded per unit of time and the changes therein, the rate c.q. the capacity of a milk and/or vacuum pump for the teat cups is controlled.
